(19) United States
(12) Patent Application Publication
(10) Pub. No.: US 2018/0246993 A1
(43) Pub. Date: Aug. 30, 2018

(54) DATA GAME TOKEN FROM DESTINATION-BASED GAMES

(71) Applicant: PANASONIC INTELLECTUAL PROPERTY MANAGEMENT CO., LTD., Osaka (JP)

(72) Inventors: John CRONIN, Bonita Springs, FL (US); Seth Melvin CRONIN, Essex Junction, VT (US); Yoshihiro OKUMURA, Osaka (JP)

(21) Appl. No.: 15/906,687

(22) Filed: Feb. 27, 2018

Related U.S. Application Data
(60) Provisional application No. 62/464,825, filed on Feb. 28, 2017.

(51) Int. Cl. G06F 17/30; H04L 29/06; G06K 7/10; H04N 5/765

(52) U.S. Cl. CPC G06F 17/30979; H04N 5/765; G06K 7/10366; H04L 63/083

(57) ABSTRACT

Embodiments for incorporating data into a token that can be provided to a guest at a location (e.g. theme park, resort, attraction, event) are described herein. The incorporated data may be recordings (e.g. images, video, audio) that capture the guest's experience while at the location. The guest's data can later be retrieved from the token and viewed on a variety of different user devices (e.g. mobile phone, laptop, desktop).

### CROSS REFERENCE TO RELATED APPLICATIONS

This application claims priority to U.S. Provisional Application No. 62/464,825 filed on Feb. 28, 2017, the entire contents of which are hereby incorporated by reference.

### BACKGROUND

### Field of Invention

The present disclosure generally relates to digital recordings. In particular, the present disclosure relates to incorporating digital recordings into tokens from which a user device can access the data stored therein.

### Description of the Related Art

Many theme parks, resorts, and other entertainment/tourist-related locations provide many products or services that help the guests commemorate the experience or occasion. For example, some locations may offer physical souvenirs for purchase. Other locations (e.g. theme parks) may offer the option to purchase digital souvenirs (e.g. photos and/or videos) that captured the occasion (e.g. rollercoaster) associated with the guest's experience. With the prevalence of mobile devices (e.g. smartphones), the traditional physical and/or digital souvenirs offered by the entertainment and tourist-related locations do not typically take advantage of the existing technology present.

### SUMMARY OF THE CLAIMED INVENTION

Embodiments of the present disclosure include systems and methods directed towards providing tokens that incorporate recordings of guests at a location. The guest experiences are captured via recordings (i.e. images, video and/or audio recordings) that are associated with attractions or events at the location. These recordings are stored in memory until requested by the guest. Once requested by the guest, the corresponding recording is retrieved from memory and stored in a token associated with the guest. The token that includes the recording can then be provided to the guest. The recording is accessible by the guest using an application stored on the user device. In this way, the recordings may be viewed by the guest in order to commemorate the guest's experience at the location while participating in the attraction or event.

### BRIEF DESCRIPTION OF THE DRAWINGS

FIG. 1 illustrates an example system.

FIG. 2 illustrates an example token.

FIG. 3 illustrates a block diagram of an example promotions software.

FIG. 4 illustrates a block diagram of an example virtual ride software.

FIG. 5 illustrates a block diagram of an example token distribution method.

FIG. 6 illustrates an exemplary computing system (i.e. user device) that may be used to implement an embodiment of the present invention.

FIG. 7 illustrates exemplary graphical user interfaces of an application compatible with the token.

FIG. 8 illustrates an exemplary flow regarding how to prepare a token to be distributed.

FIG. 9 illustrates an exemplary flow regarding how the user acquires recordings.

FIG. 10 illustrates an exemplary configuration of a token distribution system.

FIG. 11 illustrates an exemplary configuration for a power supply.

### DETAILED DESCRIPTION

The present application describes systems and methods for incorporating data into a token that can be provided to a guest at a location (e.g. theme park, resort, attraction, event). The incorporated data may be recordings (e.g. images, video, and audio) that capture the guest's experience while at the location. For example, such recordings may include a photo with various mascots found around the theme park, a video of the guest while on a rollercoaster or music that was playing at the resort that night. The token that stores the data may be a physical souvenir. For example, a physical souvenir may be a physical coin although other types of physical souvenirs are also possible. In any case, the guest data can be provided inside a product that is also decorative.

The guest's data is stored on the token using methods at the location. The guest's data can later be retrieved from the token and viewed on a variety of different user devices (e.g. mobile phone, laptop, desktop). Access to the data is carried out through various methods that allow the user devices to retrieve the data stored within the token. For example, the token may be communicatively connected to the user device. The token itself may be instructed to transmit the data to the user device upon request.

Value can be found with the sale of the various systems and methods for creating the tokens that store the guest's data offered as souvenirs at the locations. Furthermore, these tokens may also be monetized so that additional information such as advertisements is also provided as data that the guests would view.

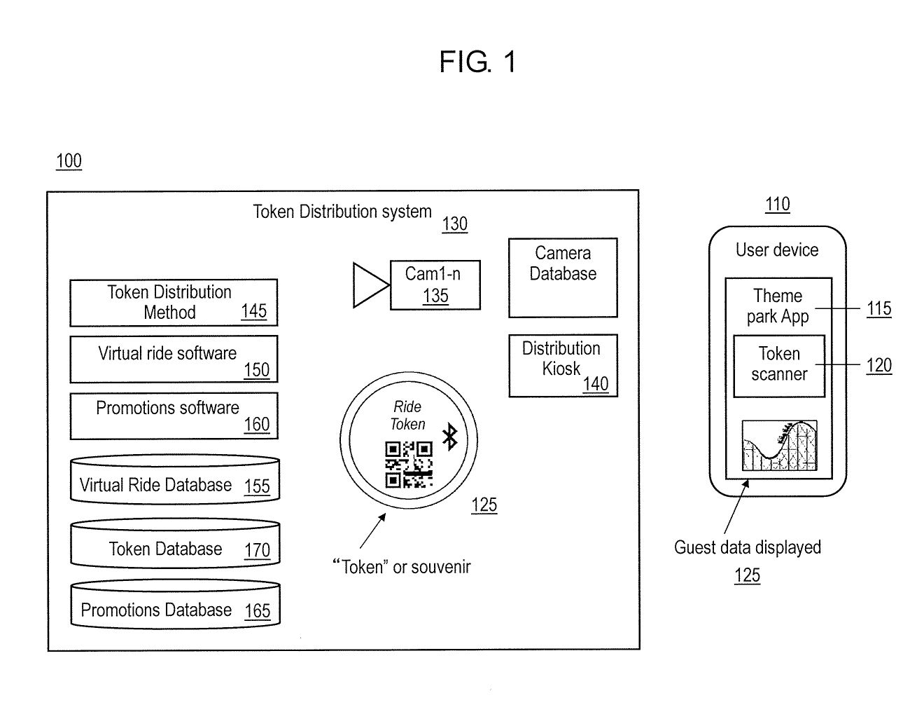

FIG. 1 illustrates an example system 100 of the present application. The system 100 may be used in various locations (such as a theme park or a resort) that provide physical commemorative items or souvenirs to guests. These commemorative items or souvenirs may include a token, printed photo, toy, or clothing. The commemorative items (aside from just having a decorative element) will also grant guests access to digital content. In an embodiment, the digital content is stored within the commemorative item.

The digital content can include digital pictures, video, audio/music, games, or text-based documents. The digital content can also be based on the location or circumstance in which the souvenir was provided to the guest. For example, a token may be provided to a guest that includes a photo or video captured while the guest was riding a rollercoaster at a theme park. The digital content that is associated with the commemorative item will be accessible by the guest when paired with a compatible user device (e.g. smartphone, laptop, and tablet).

The system 100 of FIG. 1 may include the user device 110 of the guest, the souvenir (i.e. token) 125, and the token distribution system 130 that creates and provides the tokens to the guests. Further details regarding each of the components of the system 100 as illustrated in the figure will be provided below.

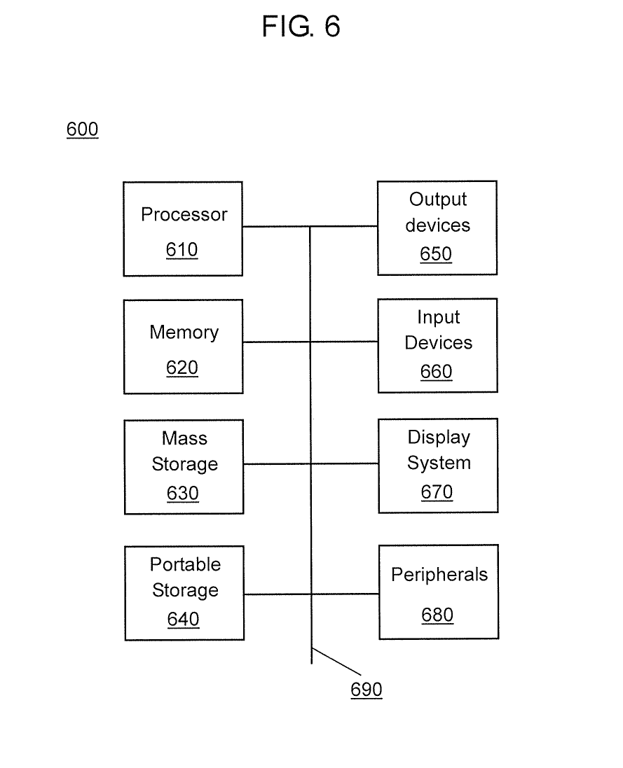

The user device 110 can be a variety of different types of known computing devices. For example user device 110 can include smartphones, laptops, desktops, and tablets. These user devices 110 may have many different characteristics such as using different operating systems (e.g. iOS, Android), applications or computing languages (e.g. C++, JavaScript). Furthermore, the capabilities (e.g. memory, processing power) may also be different from each other. Details regarding what a user device 110 may include will be provided below in FIG. 6.

The user device 110 would at least include an application 115 that would include various software modules that facilitate the guest to view, save and share the stored guest data associated with the souvenir (e.g. token 125). The application 115 may be pre-installed with the user device 110 or downloaded from a variety of difference sources. For example, the application 115 may be offered by a corresponding location that is compatible with the souvenirs offered at that location. There may be different versions of the application 115 so that different user devices 110 (which may each have their own characteristics) can be compatible with the software modules. Alternatively, the location may offer to sell user devices 110 that are designed to interact with the souvenirs offered at that location.

The user device 110 would also include a scanner 120 that facilitates the transfer of the stored guest information associated with the souvenir (e.g. token 125) to the user device 110. The scanner 120 may use, for example, a camera or Bluetooth/NFC antenna to retrieve stored guest data from the souvenir. The use of a camera as the scanner 120 may allow the guest to retrieve the stored guest data that may be associated with a barcode on the souvenir (e.g. token 125). An antenna can be used to receive information stored in memory associated with the souvenir (e.g. token 125). The information may be transmitted from the souvenir to the user device 110 to be picked up by the scanner 120 upon interaction with a feature associated with the souvenir.

Example stored guest data may include pictures, videos, audio/music, games, text and promotional information (e.g. advertisements). The stored guest data may be stored within the souvenir (e.g. token 125). In another embodiment, information may also be stored in a database separate from the souvenir. For example, the information may be stored online or in a database associated with the location that provided the souvenir. Such stored information may be retrieved based on location-based data (e.g. website/URL) stored within the souvenir. The application 115 of the user device 110 can be instructed to proceed to the location identified by the location-based data and retrieve the corresponding information for the guest.

Once the application is able to retrieve the stored guest information associated with the souvenir (e.g. token 125), such guest information is then displayed 125 on the user device 110 for the guest to view. There may be a defined display area associated with the user device 110 whereby the application 115 displays, for example, the images, videos, text or promotions associated with the souvenir.

The token 125 (as illustrated in FIG. 1) may be a souvenir offered at the location. The token 125 includes features that facilitate communication of stored guest data with user devices 110. For example, the token 125 may include a wireless connection (e.g. low power Bluetooth) used to transmit the stored guest data to the user device 110. In another embodiment, visual markings such as barcodes (or QR codes) can be used thereby allowing the user device 110 to retrieve the stored guest data upon scanning.

Aside from various decorative features associated with typical souvenirs, the token 125 may also store the guest data internally within the souvenir. In some embodiments, the token 125 may merely provide a link (i.e. location-based data such as an URL) that instructs the application 115 on the user device 110 where to go in order to retrieve the guest data. For example, the guest data linked by a souvenir offered by a theme park may store images, video and/or audio recordings of the guests' experience in a database associated with a theme park.

As described above, the system 100 includes a token distribution system 130 that creates and distributes the tokens 125 to the guests. Although tokens 125 are described with respect to the token distribution system 130, it should be noted that the distribution system 130 is compatible with other types of souvenirs as well.

As illustrated in the figure, the token distribution system 130 includes various software and databases that facilitate creating and distributing the tokens 125 used to store the guest data. The token distribution system 130 may include a plurality of cameras 135 used to capture images, video and/or audio recordings of the guests while at the location. The cameras 135 may include microphones or other devices (e.g. motion sensors) to help facilitate the capture of the images, video and/or audio recordings of the guests. The cameras 135 may be distributed throughout the location and can be associated with various attractions (e.g. rollercoasters) or events (e.g. concerts).

The cameras 135 may also be capable of identifying the guests within the captured images, video and/or audio recordings. For example, the cameras 125 may include sensors that can identify guests based on transmitted signals provided by the user device 110. The cameras 125 may also be able to identify guests based on barcodes (or QR codes) affixed to the guests' clothing (e.g. name tag). The cameras 135, once done capturing the recording of the guest, may then store the recordings into memory (e.g. camera database). The recordings can then be tagged based on the guest associated with the recording. Furthermore, the recordings may also be tagged based on the attraction or event associated with the recording.

The token distribution system 130 also includes a distribution kiosk 140 that is used to dispense the tokens 125 to the guests. For example, the distribution kiosk 140 may be a vending machine that is capable of providing the tokens 125 to the user. In some embodiments, these tokens 125 would already include the stored guest data. The distribution kiosk 140 could request the guest's identity and incorporate the guest data into the token using the various software, methods and database associated with the token distribution system 130. Alternatively, the token 125 can be provided without any guest data. The guest can subsequently approach another computing device (not shown) and provide the guest identification so that the token distribution system 130 can provide the guest data to the token 125.

In order for guests to obtain the tokens 125 from the distribution kiosk 140, the guest may be required to provide guest identity. The guest identity can be provided by the guest via a graphical user interface associated with the distribution kiosk 140. Furthermore, the distribution kiosk 140 may be capable of identifying the guest requesting the token 125 using similar means as the camera 135 (e.g. receiving transmitted signal from the guest, scanning the guest barcode or QR code). The provided guest identity allows the token distribution system 130 to associate the correct guest data to the token 125.

The distribution kiosk 140 may also require payment from the guest. The guest may input the payment via the distribution kiosk 140. Alternatively, the application 115 may also facilitate processing the payment for the token 125. The guest can provide payment information (e.g. credit cards) using the application 115 that can be transmitted to the distribution kiosk 140 or token distribution system 130.

The token distribution method 145 is used to integrate the various software and databases associated with the token distribution system 130 with the distribution kiosk 140. In this way, the token distribution method 145 identifies the guest requesting purchase of a token 125 from the distribution kiosk 140 and subsequently provides the corresponding guest data to the token 140.

As noted above, the distribution kiosk 140 may provide “blank” tokens 125 that would later be associated with guest data. The token distribution method 145 can also be associated with the other computing devices that would facilitate the association of the guest data to the token 125.

In another embodiment, the token distribution method 145 may provide a list of available guest data from the database associated with the token distribution system 130. The list may be displayed on the token distribution method 145 or other computing device that allows guests to view a thumbnail, portions or entire recordings. In this way, the guests may attempt to locate their respective recordings using a user interface associated with the token distribution method 145 or other computing device. The list can be filtered by the guest using information such as the guest identity, information regarding where the recording was taken and date/time of the recording. Once identified, the guest can select the corresponding recording to be included into their token 125. It may be possible to add multiple recordings into the same token 125.

The virtual ride software 145 generally describes software associated with the token distribution system 130 that generates the guest data (i.e. digital content) associated with the guests' experience at the location. There may be various different types of software that covers different attractions or events at the location. As described above, the guest data may include images, video and/or audio captured by the cameras 135 associated with an attraction (e.g. rollercoaster) or event (e.g. concert).

Once captured, the guest data can be stored within memory such as the virtual ride database 155. The guest data that is stored in the database 155 may correspond to the software 145 used to capture that particular type of guest data. Furthermore, the guest data stored within the database 155 may be tagged based on the date and/or time the recording was captured, guest identity of the guests within the recording and the name of the attraction or event. The tagging can be used by the token distribution system 130 and/or the guest to locate the corresponding guest data to be added to the token 125 automatically by the token distribution system 130 or upon selection/confirmation by the guest.

The promotion software 160 generally describes software that can be used to incorporate additional information apart from guest data into the tokens 125. For example, the promotion software 160 may be associated with promotions (e.g. advertisements, discounts, secret events, exclusive access, and limited collectibles) that can be associated with the tokens 125. The type of promotions that are provided by the promotion software 160 to the token may depend on the specific token 125 (or in general souvenir) received by the guest. In some situations, the promotions may be assigned based on date/time, guest identity or randomly.

The promotions are stored in an associated promotions database 165. The promotion software 160 may search for and retrieve corresponding promotions from the promotions database 165 as needed.

There may be other software similar to the promotion software 160 that incorporates different types of information into the tokens 125. For example, these other software (not shown) may incorporate data about the location or provide games or activities that the guest can participate when retrieved from the token 125.

The tokens database 170 may be used to also store any data that is associated with software contained within the token distribution system 130. For example, the token database 170 may be used to store data for the virtual ride software 150 and the promotions software 160 to be used to associate with the token 125 received by the guest. In this way, the token database 170 is used to store the guest data obtained by the token distribution system 130 that can be located by the user device 110 using location-based data (e.g. URL) retrieved from the token 125. The token database 170 may store the guest data for longer periods of time (or indefinitely) so that guests can retrieve the guest data obtained by the token distribution system 130.

Embodiments of the system 100 may include more or less elements than what is illustrated in the figure. For example, the token distribution system 130 may forgo the promotions software and promotions database if no implementation of promotions will be associated with the tokens 125. Furthermore, other types of software and databases may be included in the system 130 in order to incorporate other types of data with respect to the token 125 that are not described within this application.

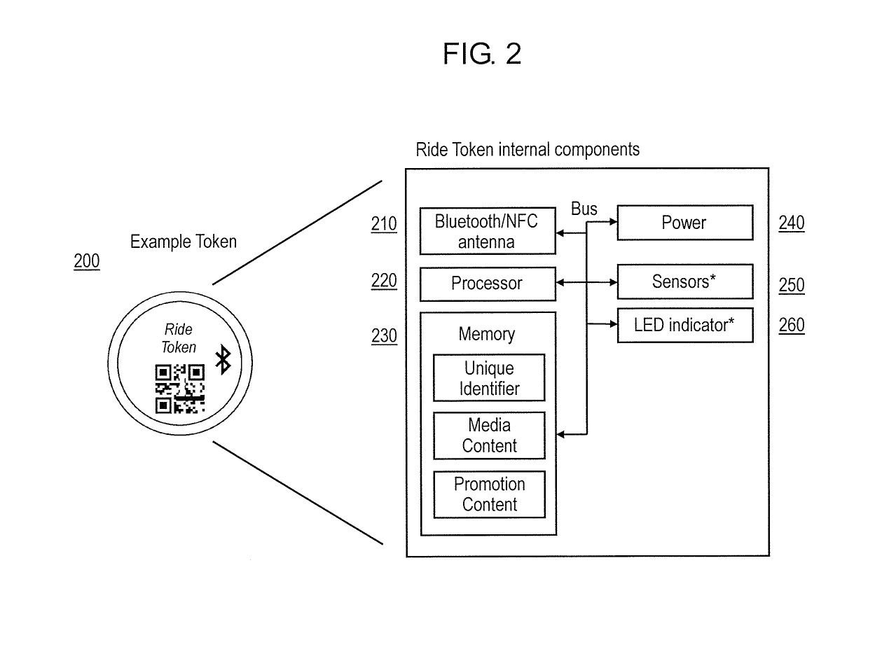

FIG. 2 illustrates an example token 200. As described above the token 200 may be any type of commemorative item (or souvenir) offered by the location that is used to store guest data. In embodiments where guest data is internally stored within, the token may include various components such as an antenna 210, processor 220, memory 230, battery 240, sensors 250, and an indicator 260 all connected to a central bus 260. These components 210-260 are used to store the guest data and later transmit the data to the user device.

The antenna 210 would be used to transmit the guest data stored in memory 230 to the user device. The antenna 210 may also be used to receive requests from the user device (via a corresponding application) requesting transmission of the guest data stored within the token 200.

The processor 220 would be used to carry out the various functions for transmitting the guest data to the user device. The processor 220 would process requests from the application to provide the guest data to the user device. The processor also performs searches for specific guest data or other content stored within memory 230.

The memory 230 may be used to store a variety of different types of information. As illustrated in the figure, the memory 230 may include a unique identifier that identifies the information stored within the token with a particular attraction, event, and/or location. The memory 230 would also include the guest data (i.e. media content) such as the image, video and/or audio recordings associated with the attraction or event at the location. The memory 230 may also include additional information such as promotions and games unrelated to the guest data but incorporated by the token distribution system 130 nevertheless.

The power supply 240 would provide the power needed to run the various components within the token 200. The power supply 240 may be implemented via single-use or disposable batteries or via batteries that can be re-charged using an external charger.

The sensors 250 may be used to detect when the guest may request transmission of guest data from the token 200. It may be possible that the token 200 operates in a low-power mode to conserve battery power until something is detected. The sensors 250 may detect, for example, whether a user device is nearby or physical contact by the guest. Based on the reaction from the sensors 250, the token can be initiated into a normal operational mode. The processor 220 may proceed with retrieving specific guest data from memory 230 (for example based on guest input from the application on the user device) and provide it to the antenna 210 for transmission to the user device.

The indicator(s) 260 (i.e. LED lights) may be used to provide various types of information associated with the token. There may be a plurality of different indicators or indicators that provide different colors or effects (i.e. flashing, color intensity). Different types of information can be conveyed to the guest based on, for example, the frequency of the indicators turning on or off, the color, and the intensity of the color. Furthermore, multiple indicators can be used to convey different types of information.

For example the indicator 260 can provide information regarding whether the internal components within the token 200 are on/off. Furthermore, the indicator 260 can provide the status of the power supply. The indicator 260 can also be used to confirm whether transmission of the guest data (or other data stored within the memory 230) has not started, is in progress or completed.

In other embodiments, the token may have a visual barcode or QR code that can be scanned by the user device (via a scanner and associated application). The information associated with the visual barcode or QR code can be translated to provide the location-based data directing the application to retrieve the corresponding guest data. The location-based data may be a URL or other information directing the application to a database where the guest data is stored. For example, there may be a database associated with the location that provided the token.

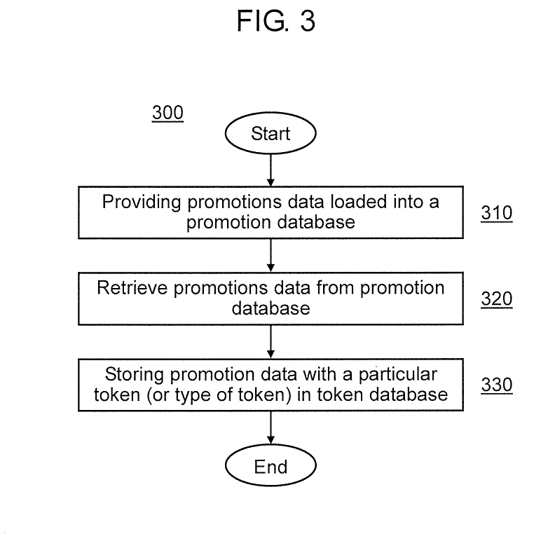

FIG. 3 illustrates a block diagram of an example promotions software. As described above, the promotions software can be used to incorporate additional information apart from guest data into the tokens. For example promotional information such as advertisements, discounts, secret events, exclusive access, and limited collectibles can be incorporated into the tokens. When the guests retrieve guest data from the tokens, the promotional information may also be provided for the guests to view on their user device.

In step 310, promotional data is loaded into the promotion database. The promotion database may be managed by the location for promotions associated with the location. The promotion database may also allow third parties to provide promotional information to various guests via the promotion software. There may also be multiple promotional databases associated with the promotion software where each database may correspond with an entity offering promotions for the guest.

In step 320, the promotional software retrieves various promotions from the promotion database to be incorporated into the token. The promotion software can retrieve promotions to be included in the token based on various criteria. For example, promotions may be included based on the type of souvenir that will be provided to the guest. Alternatively, the included promotions may be based on the location, the attraction, or the event, the souvenir (i.e. token) is associated with. Other criteria may include the date/time the souvenir was obtained by the guest or the guest identity. Furthermore, the promotions may also be assigned to various souvenirs randomly.

In step 330, the retrieved promotions can be associated with the souvenir. In some embodiments, the information associated with the promotions may be stored directly in the souvenir (i.e. token). In other embodiments, location-based information (e.g. URL) can be provided that would direct the user device to a particular database that would store the promotions associated with the guest.

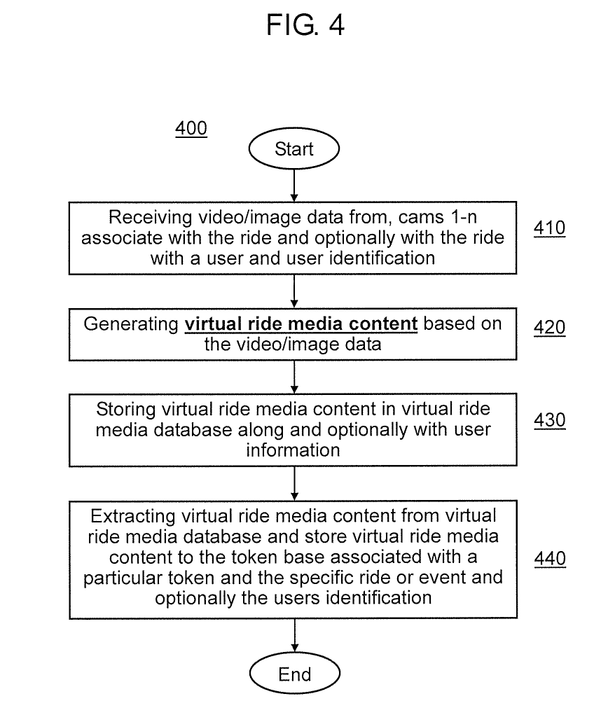

FIG. 4 illustrates a block diagram of an example virtual ride software 400. As described above, the virtual ride software 400 corresponds to software that facilitates the generation of the guest data (i.e. digital content) that captures the guests' experience at the location. For example, the virtual ride software 400 can facilitate the capture of image, video and/or audio recordings that would be viewable by the guest associated with an attraction (e.g. rollercoaster) or event that the guest participated in at the location.

In step 410, the virtual ride software can receive image, video and/or audio recordings from various cameras at the location. These cameras may be associated with particular attractions or events. Furthermore, these cameras may also include microphones or other devices (e.g. sensors) that facilitate the capture of the recordings.

In step 420, the captured image, video and/or audio recording is processed in order to generate digital content that can be stored in the souvenir (i.e. token). In some situations where the digital content is not stored in the souvenir but rather an external database, a corresponding location-based identifier (i.e. URL) can be generated that would direct the user device to the location of where the digital content is stored. As described above, this location-based identifier would be stored in the souvenir. Upon receipt of the location-based identifier by the user device, the user device can proceed to retrieve the digital content (i.e. guest data) from the external database.

In step 430, the generated digital content may be stored in memory until it is transferred to a souvenir for the guest. Alternatively, the generated digital content may be stored in an external database where it can be accessed by user devices using the location-based identifier that would be included in the souvenir.

The generated digital content, when stored in the database or the external database, may be associated with user information. The user information, such as guest identification, may be tagged to the generated digital content so that content can be organized and searchable.

In step 440, the digital content (or location-based identifier) is stored in the souvenir. In addition, information about what digital content is stored in which souvenir may be stored in a separate database (e.g. token database). Each souvenir may be identified with a unique identifier.

The use of the identifiers for each souvenir may be useful in situations where the digital content is stored in an external database. The user device, upon finding the location where the digital content is stored using the location-based identifier, can then be provided the appropriate digital content based on the identifier associated with the souvenir that provided the location-based identifier.

The token database can then be used to associate what digital content belongs to which guest. The token database may also include guest identification and information associated to where and/or when the digital content was obtained.

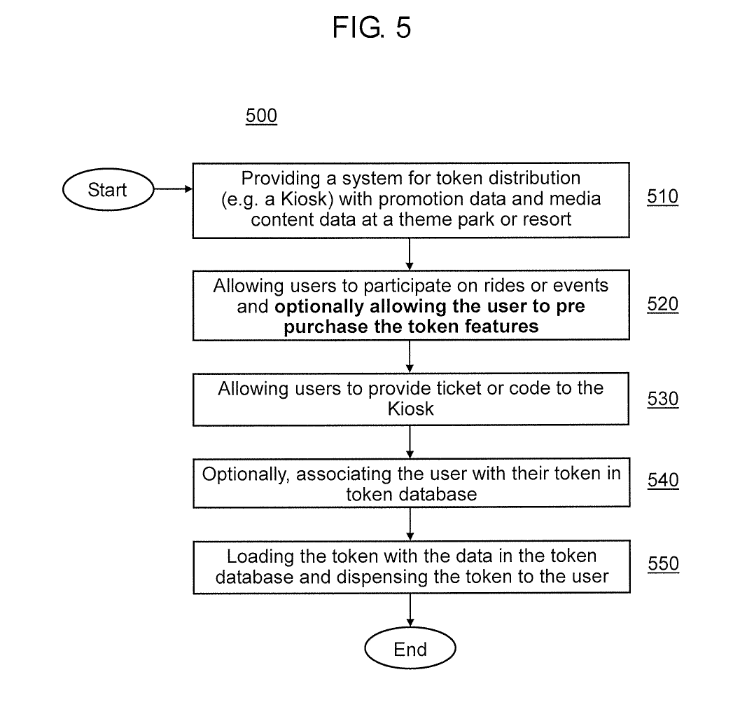

FIG. 5 illustrates a block diagram of an example token distribution method 500. The token distribution method integrates the various software and databases associated with the token distribution system in order to identify what guest data should be stored in the token that will be provided to the guest, for example, at a token distribution kiosk.

In step 510, the token distribution method is provided a way for distributing tokens (e.g. kiosk). The method 500 would also be provided with promotional data that can be included into the souvenirs (i.e. tokens).

In step 520, guests participate in various attractions or events located at the location. During the participation, the guests' experiences are captured by the various cameras, microphones and other devices throughout the location. These experiences are captured via images, video and/or audio recordings.

Prior to participating in the attraction or event at the location, the guests may be offered the ability to pre-purchase tokens. The guests may be provided information that their experience may be captured via recordings and provided via a token after participation in the attraction or event has ended. The pre-purchase can be completed, for example, on an application on the user device or at a dedicated token distribution kiosk. Pre-purchase, after completed, may provide the guest a guest identification that can later be redeemed at the token distribution kiosk.

In step 530, the guests can proceed with purchasing the token after the attraction or event has ended if the tokens were not pre-purchased beforehand. Once purchased, the guests may be provided a ticket or code that can be used to redeem at a token distribution kiosk. The ticket or code may include a guest identification. Furthermore, the ticket or code can confirm payment for the token so that the token can be distributed to the guest.

In step 540, the token distribution method can associate the specific guest (via the guest identification) with a token that will be provided to them. This association may be stored in the token database. Such association may be important in situations where the recordings are not directly stored on the souvenir but rather in a separate database (e.g. token database). In particular, the association can help identify what guest data belongs to the guest identified by the token.

In step 550, data is stored onto the souvenir. The guest data may be directly stored in the souvenir (within memory in the souvenir itself). In other situations, a barcode, QR code or other location-based identifiers (URL) may be associated with the souvenir that would direct the user device to where the guest data may be retrieved. Once the data is stored with the souvenir, the token can be dispensed to the guest.

FIG. 6 illustrates an exemplary computing system 600 (i.e. user device) that may be used to implement an embodiment of the present disclosure. The computing system 600 of FIG. 6 includes one or more processors 610 and memory 620. Main memory 620 stores, in part, instructions and data for execution by processor 610. Main memory 620 can store the executable code when in operation. The system 600 of FIG. 6 further includes a mass storage device 630, portable storage medium drive(s) 840, output devices 650, user input devices 660, a graphics display 670, and peripheral devices 680.

The components shown in FIG. 6 are depicted as being connected via a single bus 690. However, the components may be connected through one or more data transport means. For example, processor unit 610 and main memory 620 may be connected via a local microprocessor bus, and the mass storage device 630, peripheral device(s) 680, portable storage device 640, and display system 670 may be connected via one or more input/output (I/O) buses.

Mass storage device 630, which may be implemented with a magnetic disk drive or an optical disk drive, is a non-volatile storage device for storing data and instructions for use by processor unit 610. Mass storage device 630 can store the system software for implementing embodiments of the present invention for purposes of loading that software into main memory 620.

Portable storage device 640 operates in conjunction with a portable non-volatile storage medium, such as a floppy disk, compact disk or Digital video disc, to input and output data and code to and from the computer system 600 of FIG. 6. The system software for implementing embodiments of the present invention may be stored on such a portable medium and input to the computer system 600 via the portable storage device 640.

Input devices 660 provide a portion of a user interface. Input devices 660 may include an alpha-numeric keypad, such as a keyboard, for inputting alpha-numeric and other information, or a pointing device, such as a mouse, a trackball, stylus, or cursor direction keys. Additionally, the system 600 as shown in FIG. 6 includes output devices 650. Examples of suitable output devices include speakers, printers, network interfaces, and monitors.

Display system 670 may include a liquid crystal display (LCD) or other suitable display devices. Display system 670 receives textual and graphical information, and processes the information for output to the display device.

Peripherals 680 may include any type of computer support device to add additional functionality to the computer system. For example, peripheral device(s) 880 may include a modem or a router.

The components contained in the computer system 600 of FIG. 6 are those typically found in computer systems that may be suitable for use with embodiments of the present disclosure and are intended to represent a broad category of such computer components that are well known in the art. Thus, the computer system 600 of FIG. 6 can be a personal computer, hand held user device, telephone, mobile user device, workstation, server, minicomputer, mainframe computer, or any other user device. The computer can also include different bus configurations, networked platforms, multi-processor platforms, etc. Various operating systems can be used including Unix, Linux, Windows, Macintosh OS, Palm OS, and other suitable operating systems.

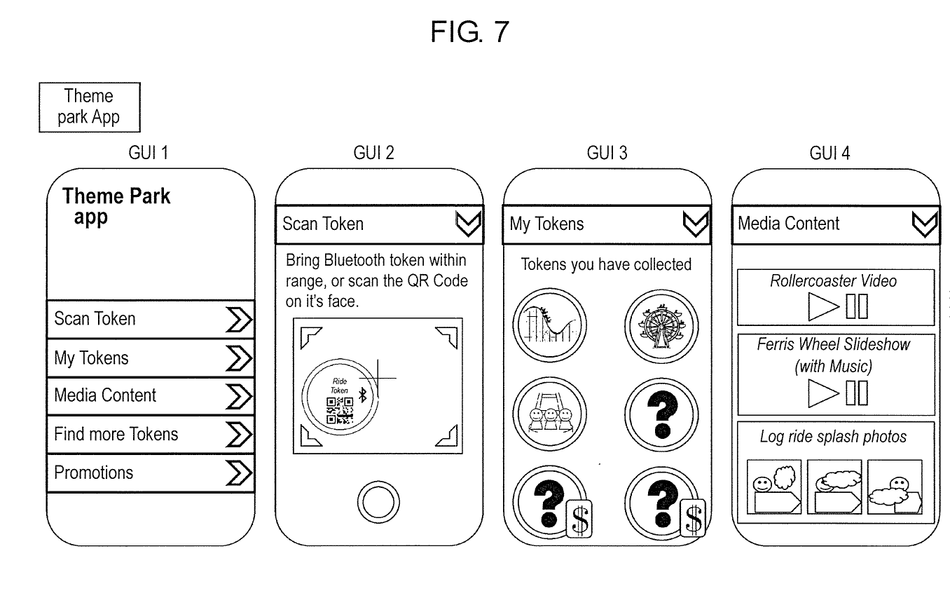

FIG. 7 illustrates example graphical user interfaces of an application compatible with the token. The application stored on the user device provides various ways that the guest can interact with the souvenir (i.e. token).

With respect to GUI 1, this is an example main menu that provides various options that the guest can select. ‘Scan token’ may instruct the user device (via the application) to scan a corresponding token for any available guest data associated with the token. For example, the data may be stored within the token and would thus be retrieved from memory. In another embodiment, the token may include a barcode or QR code that can direct the application to where the guest data can be retrieved.

‘My Tokens’ may include a list of tokens that were previously scanned by the guest using the application. In some embodiments, once a token has been scanned, information about the token may be stored on the user device. In this way, the user can view what tokens have been scanned.

‘Media content’ may list all the guest data that has been retrieved in connection with the scanned tokens. The guest data (e.g. image, video and/or audio recordings) may be retrieved from the token or downloaded from an external database and stored on the user device. In this way, the guest can view all previously retrieved guest data without the need to re-scan tokens.

‘Find more tokens’ may be a feature that lists what tokens may be available for the guest to purchase. In embodiments where the application itself is associated with a particular location, this feature may list what tokens may be offered at the location and where they may be found.

‘Promotions’ may be a feature that lists all the promotional information that has been retrieved in connection with scanned tokens. These promotions (e.g. advertisements) may be stored in the user device and displayed upon request.

With respect to GUI 2, this provides an example embodiment where a token is being scanned using the application on the user device. In an embodiment, the token may include Bluetooth technology. When the token is within a pre-determined distance from the scanner of the user device, the application can attempt to retrieve the stored guest data within the token. Alternatively, if the token includes a barcode or QR code, the scanner can attempt to identify and process the barcode or QR code in order to identify the location where the guest data is actually stored.

With respect to GUI3, a list of tokens can be displayed for the guest to view on their user device in the application. The list of tokens may be represented via an image associated with the stored recording or with a representation of the token itself.

In some embodiments, the list of tokens may be interactable by the guest in that selection of a particular token may bring up a new GUI (e.g. GUI 4). GUI 4 provides the actual guest data (e.g. image, video and/or audio recordings) that can be viewed by the user on the user device using the application. The application may include various digital content players that would facilitate playing video and/or audio recordings on the user device.

Referring again to FIG. 2, the memory 230 of the token 200 also stores recordings before distribution. After termination of the corresponding service, the user cannot acquire recordings from online server of the service. In this configuration, the user can acquire recordings stored in the token 200. It allows the user device to acquire the recordings, even when corresponding services are no longer available.

The token 200 may include the memory 230 which stores an unique identifier. Before distributing each token, the unique identifier is stored into the memory of the token. The unique identifier may identify particular attractions, events, and/or locations. The unique identifier may also include information for identifying each token. Therefore, personal information of the user (or the guest) may be identified, when associating information is available. The associating information which indicates correspondence between the unique identifier and personal information managed by a server. In such configuration, personal information, which is not suitable to be included in the token in terms of security, can be associated with the guest.

The token may include a wireless transceiver to communicate with the user device. The user of the user device can send a request signal to the token for acquiring the recording. The wireless transceiver of the token receives the request for the recording from the guest via the user device. The wireless transceiver may support low power communication. For example, low power Bluetooth and/or NFC (Near Field Communication).

The token distribution system 130 includes in-part the token 200 and a recording system 135. The token may include the memory, the wireless transceiver and a processor. The processor controls the token.

The recording system may include a recorder to record recordings which is guest participation (recordings of the guest's experience) in an attraction or event at a location. The guest participation is associated with a guest who is associated with the token. In other words, when the token is distributed for a guest, the memory stores the recordings which are recorded by the recorder for the guest.

The processor performs, for example, (i) receiving the request for the recording from the guest via the wireless transceiver, (ii) retrieving the recording associated with the guest from memory and (iii) transmitting the retrieved recording to the user device via the wireless transceiver. This configuration, where the token includes the processor and the wireless transceiver, allows the user of the user device to access the recordings with the token.

The processor can also transmit recordings from the memory of the token. The memory may include one or more recordings. The processor retrieves the appropriate recordings according to the request from the user device and transmits the retrieved recordings.

The token may further include a power circuit 240 which supplies power for the token. The power circuit may be capable of receiving electrical power from an antenna. The antenna can be the antenna for the wireless communication. However, the antenna is not necessarily the antenna for the wireless communication. In such configuration, the power supply for the token is ensured after years from the experience. The battery 240 may be omitted or capacity of the battery 240 can be suppressed.

The token distribution system may also include software installed on the user device. The user device may include a processor, token distribution software for managing the token and a second wireless transceiver. The processor executes the token distribution software. The processor acquires the unique identifier of the token and the recordings stored in the memory of the token via the second wireless transceiver and the wireless transceiver of the token.

The token may store appearance information associated with the recordings stored in the token. The processor determines appearance on the interface of the token distribution software according to the appearance information stored in the memory of the token. This configuration allows the user device to show original images of appearance at the time of distribution of the token, whether corresponding services provided by servers are available or not.

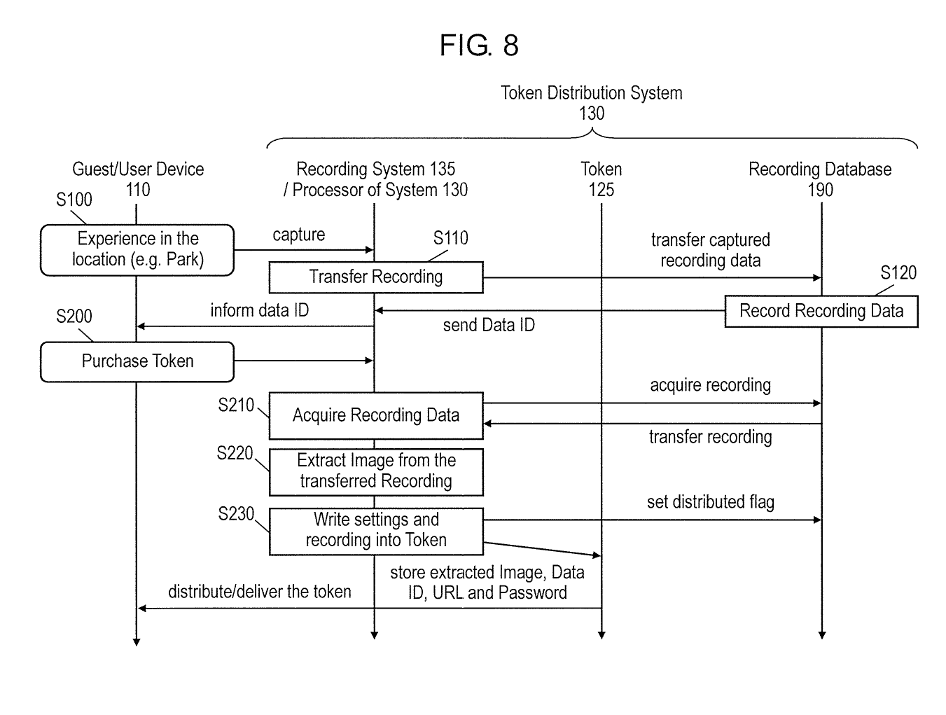

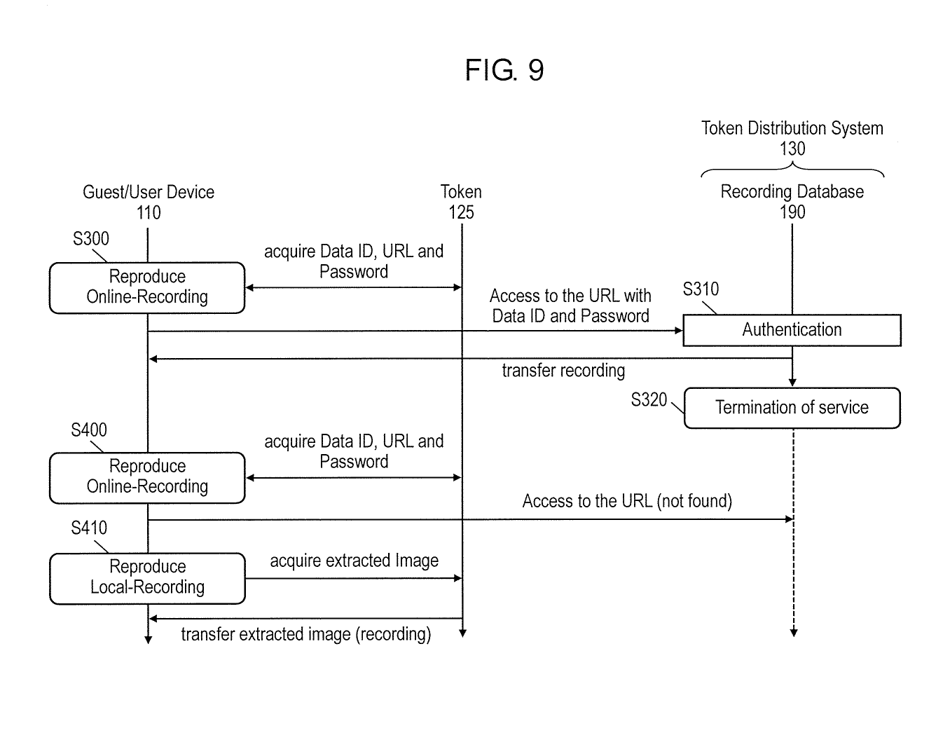

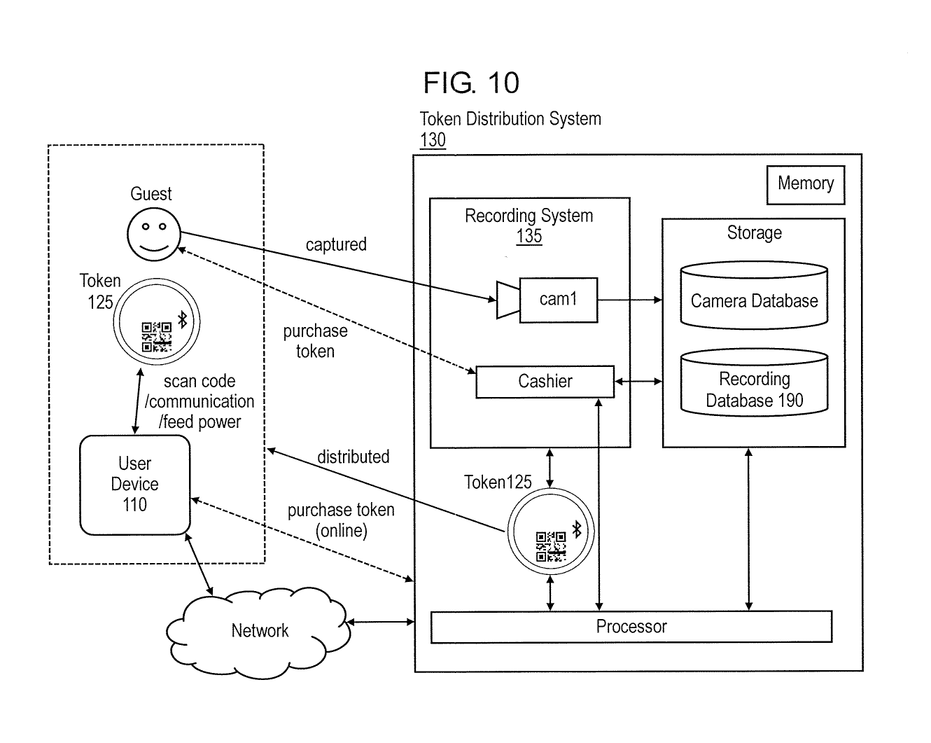

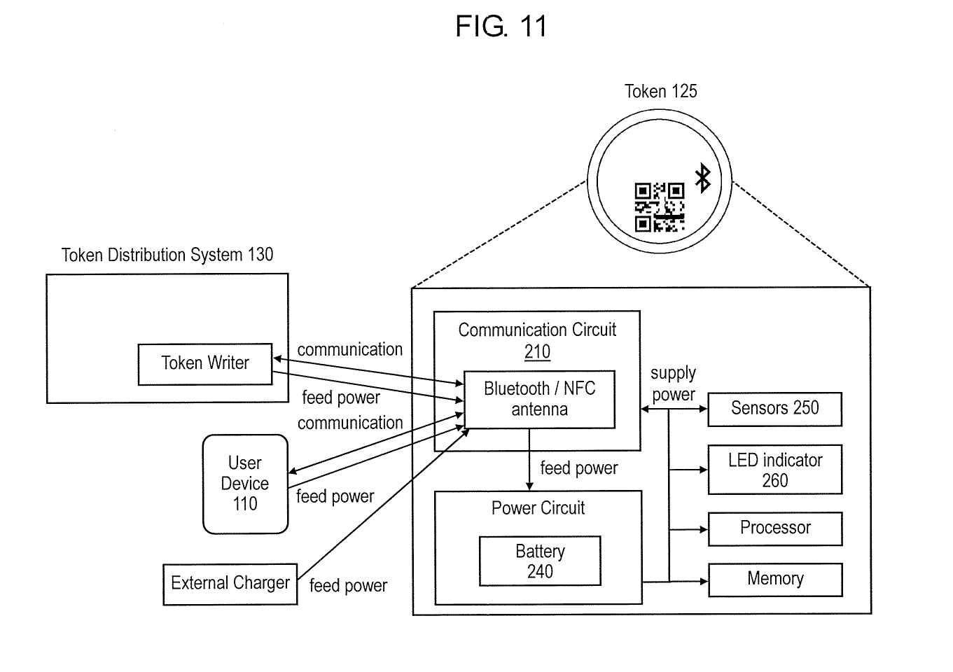

FIGS. 8-11 show exemplary configurations. FIG. 8 shows an exemplary flow regarding how to prepare a token 125 to be distributed. FIG. 9 shows an exemplary flow regarding how the user acquires recordings corresponding to a token 125. FIG. 10 shows an exemplary configuration of a token distribution system 130. FIG. 11 shows an exemplary configuration for a power supply.

Camera 135 may capture an experience of a guest in the location (S100). Recording system 135 (or processor of the system 130) transfers the captured recording data to recording database 190. Recording database 190 records the transferred recording data and assigns an identical data identifier (S120). The recording system 135 or the processor of the distribution system 130 informs the data ID for the guest so that the guest can specify the recording data later. The recording database 190 may be independent from the camera database. The recording database 190 may be implemented, for example, as a server or implemented on a cloud service. In such configuration, recordings transferred from camera 135 are stored into camera database. The processor transfers recording data to the recording database 190 selectively.

As shown in FIG. 10, the guest can purchase the token 125 at a cashier or via an online service (S200 of FIG. 8). The cashier may be combined with the recording system 135. The user sends or indicates the data ID to specify the recording data to be stored into the purchased token. The processor acquires the specified recording data from the recording database 190 (S210).

The processor may generate smaller recording data to reduce the data size. For example, the processor extracts still image and/or trims the area of the recording (S220). It allows storing recording data into limited size of memory 230 of the token 125. It also suppresses power consumption to transfer extracted recording data from the token 125 to the user device 110. The capacity of the battery of power circuit 240 is limited by space inside the token 125. The power consumption of the token 125 depends on the wireless communication circuit 210 including a power amplifier which feeds the antenna. Reducing data size of transmitted information decreases power consumption of the wireless communication circuit 210. Therefore, capacity of the battery of the power circuit 240 can be reduced. For example, the battery can be realized with a capacitor.

The processor writes settings and the extracted recording into the memory 230 of the token 125 (S230). The settings include the data ID of the recording, the URL of the service which distributes the recording data and the password for the service. The processor also sets a flag of recording database 190 to indicate the target recording data have been distributed. The flag is used for screening recording data to be erased for saving storage. For example, the recording data having the flag is prohibited to be erased and stored in active storage or near-line storage.

After writing the settings and the extracted image, the token 125 is distributed to the guest. The distribution method is not limited to any specific delivery method. For example, the token 125 can be obtained, for example, at a shop in the park, by vending machine or via mail.

The guest can reproduce both the online-recording, stored in recording database 190, and local-recording stored in the token 125. When the guest reproduces online-recording, the guest acquires information from the token 125 using the user device 110 (S300). The token 125 transmits data ID, URL and password to the user device 110. The user device 110 tries to access to the URL with the data ID and the password. The token distribution system 130 authenticates the access (S310). When the access passes the authentication, the token distribution system 130 transmits the recording, specified with the data ID, to the user device 110.

However, when the token distribution system 130 or the recording database 190 is out of service, the guest cannot acquire recordings from the recording database 190 (S400). In such a situation, the user device 110 acquires extracted images stored in the token 125. The token 125 transfers extracted images to the user device 110. The token 125 may transfer an extracted image via a broader connection, i.e. Bluetooth, than NFC. The configuration saves power consumption before the termination of the service. The token 125 may be recharged by wireless charging via the antenna of communication circuit 210.

FIG. 10 shows an exemplary configuration of token distribution system 130. Recording system 135 includes a device for capturing recording of guest. Recording system 135 may include a cashier for payment. The cashier may include an apparatus for distributing token 125 which is connected to network of token distribution system 130. When a guest purchases a token at the cashier, the cashier writes information to the token 125 as shown in FIG. 8. The guest can purchase the token via the network. In this case, the data ID of corresponding recording is informed to the guest. The guest can purchase the token 125, specified by the data ID, via the network. A processor of the token distribution system writes corresponding information to token 125 and the token 125 is distributed to the guest. The token 125 has some interface to provide information to the user device 110. For example, the user device can scan a barcode or QR code printed on the token 125. The token 125 has wireless communication interface, i.e. Bluetooth and NFC. Token 125 can be supplied power from the user device 110 or external charger.

FIG. 11 shows an exemplary configuration for a power supply. The token writer of token distribution system 130 can communicate with the token 125 for writing information and feed power for the token 125. The power circuit of token 125 receives the power via the antenna of communication circuit 210. The antenna may also be used for communication. When token 125 is communicating with user device 110, the user device 110 can feed power to the token 125. However, the token 125 should be kept close to the user device 110 for stable power supply. The battery 240 improves stability of the power supply and allows moving the token 125 away from the user device 110 when the token 125 is communicating with the user device 110. Therefore, once communication between the token 125 and the user device 110 is established, the token 125 can be removed from the user device 110. An external charger may feed power to the token 125 when the token 125 is put on the external charger.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims set forth below.

What is claimed is:

1. A method for providing tokens that incorporate recordings of guests at a location, the method comprising:
recording guest participation in an attraction or event at a location;
storing the recording in memory;
receiving a request for the recording from the guest;
retrieving the recording associated with the guest from memory;
associating a token with the guest;
storing the recording in the token associated with the guest; and
distributing the token to the guest, wherein the recording stored in the token is accessible by a user device using an application stored on the user device.

2. The method of claim 1, wherein the token includes the memory and a unique identifier which associates the token with the guest is stored in the memory, and the token is identified based on the unique identifier.

3. The method of claim 1, wherein the token includes a wireless transceiver to communicate with the user device, the wireless transceiver performs the receiving the request for the recording from the guest.

4. A token distribution system comprising:
a token including:
a memory which stores unique identifier,
a wireless transceiver to communicate with a user device, and
a first processor to control the token,
a recording system including:
a recorder to record recordings regarding guest participation in an attraction or event at a location, the guest participation is associated with a guest who is associated with the token,
wherein the recordings associated with the guest are stored in the memory of the token, and the first processor performs receiving a request for the recording from the guest via the wireless transceiver, retrieving the recording associated with the guest from the memory, and transmitting the retrieved recording to the user device via the wireless transceiver.

5. The token distribution system of claim 4, wherein the wireless transceiver of the token includes an antenna for wireless communication between the token and the user device.

6. The token distribution system of claim 5, wherein the token further includes a power circuit which supplies power for the token, the power circuit is configured to receive electrical power from the antenna.

7. The token distribution system of claim 5, wherein the user device further includes:
a second processor which executes a token distribution software,
a token distribution software for managing the token,
a second wireless transceiver which communicates with the wireless transceiver of the token,
the second processor acquires, via the second wireless transceiver and the wireless transceiver of the token, unique identifier of the token and the recordings stored in the memory of the token.

8. The token distribution system of claim 7, wherein the second processor determines appearance of the token on an interface of the token distribution software according to an appearance information stored in the memory of the token.
